(19) United States
(12) Patent Application Publication
(10) Pub. No.: US 2019/0327551 A1
(43) Pub. Date: Oct. 24, 2019

(54) WIRELESS HEADPHONE SYSTEM

(71) Applicant: Mohammed AL-AMIN, Chelmsford, Essex (GB)

(72) Inventor: Mohammed AL-AMIN, Chelmsford, Essex (GB)

(21) Appl. No.: 16/314,167

(22) PCT Filed: Jun. 30, 2017
(86) PCT No.: PCT/GB2017/051923

§ 371 Date: Dec. 28, 2018

(30) Foreign Application Priority Data
Jun. 30, 2016 (GB) 1611423.3

(51) Int. Cl. H04R 1/10

(52) U.S. Cl. CPC H04R 1/1041; H04R 2420/01; H04R 2420/07

(57) ABSTRACT

The present invention relates to a wireless headphone system in which a controller is coupleable to a source and configured to receive data from the source (for example a media player, mobile phone, tablet computer, laptop or desktop computer etc), and a pair of headphones is configured to be wireless couple to the controller or source in order to receive media from the source and output the media as audio. The headphones may also output headphone data. The source data and headphone data are presented to the user on a screen on the controller, and the user may issue control commands via a controller user interface in order to control the source. Furthermore, the headphones may also be charged via the controller.

### FIELD OF THE INVENTION

The present invention relates to a wireless headphone system, in particular to a wireless headphone system comprising a controller for receiving user commands and issuing user commands to a source to control the source.

### BACKGROUND OF THE INVENTION

Bluetooth® is used for the communication of data and audio from a master (source) device to a slave device at short distances, each slave and master device is uniquely identified and are connected to each other via pairing. One such application is in the use of wireless headphones, which free the user from having cables extending from a source (for example a media player, mobile phone, tablet computer, laptop or desktop computer etc) to the headphones, which output audio from the media received from the source. However, such solutions rarely provide for controls to enable the user to control the source of the media.

FIG. 1 illustrates a known solution to this, in which a controller 1 is wireless connected to a source 2. Headphones 4, 6 are connected using a wire to the controller 1. However, this solution is not always satisfactory as the cables can get in the way of the user and become entangled; this solution does not offer a truly wireless experience.

We have thus identified the need for an improved wireless headphone system.

### SUMMARY OF THE INVENTION

The present invention therefore provides a wireless headphone system, comprising: a controller coupleable to a source, and comprising a display and a user interface for receiving user commands; and a pair of headphones comprising first and second headphone channels, the pair of headphones being wirelessly coupleable to the controller or source, and configured to receive media from the source, to output the received media as audio, and to output headphone data, wherein the controller is configured to receive source data from the source and the headphone data and to display the source data and headphone data to a user on the display, and wherein the controller is configured to issue user commands received from the user interface to the source to control the source.

In a first arrangement, when the pair of headphones is wirelessly coupled to the source, the controller is wirelessly coupled to the source .The controller may be wirelessly coupled to the source via the pair of headphones. The controller may be wirelessly coupled to the first or second headphone channel.

In this first arrangement, the controller may be configured to receive source data from the source via the pair of headphones, and configured to issue user commands to the source via the pair of headphones.

In a second arrangement, when the pair of headphone is wirelessly coupled to the controller, the controller is coupled to the source. The controller may be coupled wirelessly to the source, or connected to the source using a wired connection. The pair of headphones may be configured to receive media from the source via the controller.

In any of the above arrangements, the controller may be configured to issue control commands to the pair of headphones.

The controller may comprise an input for receiving the pair of headphones in a wired connection. For example, the controller input may comprise a docking port for receiving the pair of headphones in a wired connection.

When the controller comprises an input for receiving the pair of headphones in a wired connect, the controller may also comprise a charging system, and wherein the controller is configured to charge the pair of headphones when the headphones are connected to the input in a wired connection. Also, when the pair of headphones are connected to the controller input in a wired connection, the controller may configured to issue a command to the pair of headphones to cause the pair of headphones also to be connected wirelessly to the controller. This may occur whether or not the headphones are being charged by the charger. When the pair of headphones are disconnected from the controller input, the pair of headphones may configured to resume its wireless connection prior to being connected to the controller in a wired connection.

The user commands may comprise one or more of a fast forward command, rewind command, play command, pause command and stop command in order to control the source. The headphone data may comprise one or more of a connection status, and a battery level status. The source data may comprise one of more of: media data associated with the media and source device data indicating a condition, mode or status of the source.

The controller user interface may comprise one or more buttons or a touch-screen interface for issuing a user command.

In any of the above, the source comprises a mobile phone, a tablet computer, a laptop computer, a desktop computer, a games console or a media player.

Furthermore, the wireless protocol may be Bluetooth®.

The pair of headphones may comprise in-ear headphones, or over the ear headphones. The first and second headphone channels may comprise a respective first and second disconnect sensor for sensing when the respective first or second headphone channels are removed from a user.

The disconnect sensor may comprises an optical sensor for detecting the presence of a user when in proximity of a user. When one or more of the first and second headphone channels are detected as being removed from a user, the detected removed channel headphone may be configured to enter a low power consumption mode to reduce power consumption of the channel headphone, or the detected removed channel headphone may be configured to turn off.

When one or more of the first and second headphone channels are detected as being removed from a user, the controller may be configured to pause or stop the media.

In any of the above, one or more channels of the headphones may comprise a capacitive sensor to detect the presence of a body nearby the headphone channel, or adjacent the headphone channel, and wherein the detection of the presence of a body controls the operation of the headphone or the playing of the media. The sensed body may be part of the user using the headphones. A body detected as being nearby the headphone channel by the capacitive sensor may be a head or ear of the user, and a body detected as being adjacent the headphone channel may be a finger of the user when the user presses a finger against the headphone channel.

In any of the above, the pair of headphones comprises an active noise control system for reducing background noise external to the pair of headphones being heard by the user.

### LIST OF FIGURES

The present invention will now be described, by way of example only, and with reference to the accompanying figures, in which:

FIG. 1 shows a prior art system of a controller and headphones;

FIG. 2 shows the connections between a controller, source and earphones according to the invention;

FIG. 3 shows alternative connections between a controller, source and earphones according to the invention;

FIG. 4 shows alternative connections between a controller, source and earphones according to the invention;

FIG. 5 shows alternative connections between a controller, source and earphones according to the invention;

FIG. 6 shows alternative connections between a controller, source and earphones according to the invention;

FIG. 7 shows a simplified block diagram of some of the components comprising the controller; and

FIG. 8 shows an example layout of the controls and display of the controller.

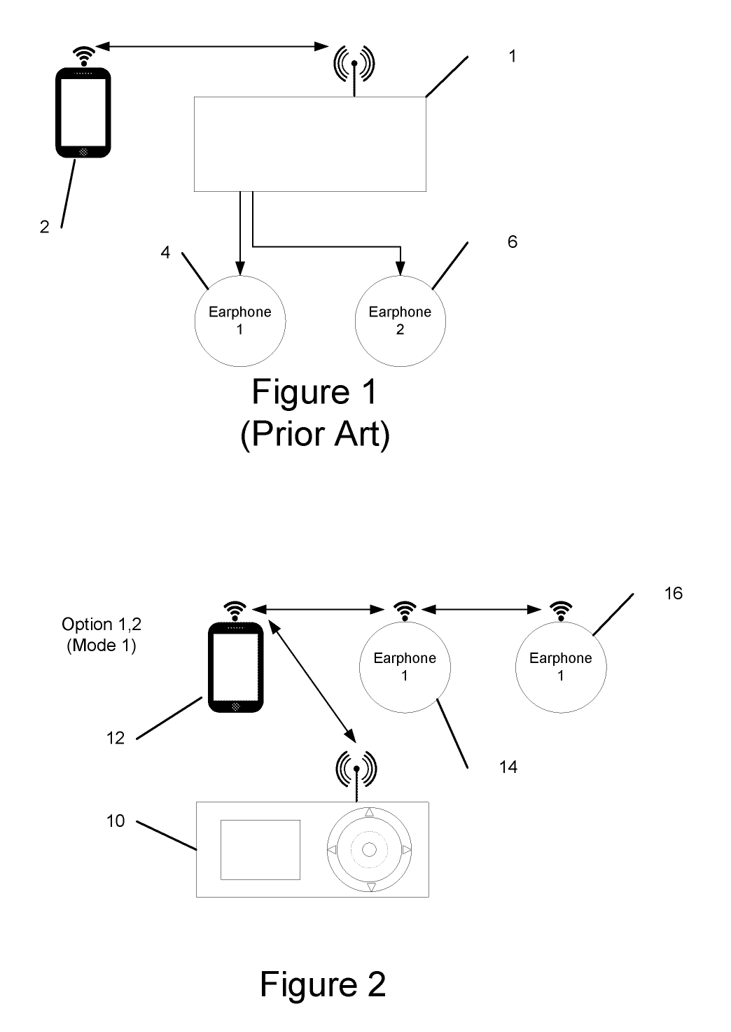

### DETAILED DESCRIPTION OF THE PREFERRED EMBODIMENTS

Portable Bluetooth® applications are able to provide control commands from a slave device using such protocol profiles such as AVRCP, HSP, HFP, etc. The protocols also provide information back to a slave device, such as music track being played or caller ID, etc.

Wireless earphones using Bluetooth® communications have been used to provide A2DP audio streaming and HFP communications from one earphone to the other, this was achieved via CSR's Truewireless® technology.

The present invention may utilise the above in order to provide the user with an improved listening experience.

In brief, the present invention provides a wireless headphone system in which a controller is coupleable to a source and configured to receive data from the source (for example a media player, mobile phone, tablet computer, laptop or desktop computer etc), and a pair of headphones is configured to be wireless couple to the controller or source in order to receive media from the source and output the media as audio. The headphones may also output headphone data. The source data and headphone data are presented to the user on a screen on the controller, and the user may issue control commands via a controller user interface in order to control the source. Thus, an improved wireless headphone system may be provided.

FIGS. 2 to 6 illustrate various connection schemes that may be used with the wireless headphone system of the present invention. We will take each in turn. In any of the schemes shown in these figures, the headphones 14, 16 may be over the ear headphones or in-the-ear earphones or earbuds. Similarly, the source 12 may be a mobile phone, a tablet computer, a laptop computer, a Personal Computer, a games console or a media player or any other type of source that is capable of providing media to be played on the headphones 14, 16. In any of these schemes, earphone 14 may be the left or right channel, and earphone 16 may be the right or left channel respectively.

FIG. 2 illustrates a first connection scheme between a source 12, controller 10 and earphones 14, 16. In this scheme, the controller 10 wirelessly connects to the source 12, and one of the earphones 14 wirelessly connects to the source 12 to receive the media. A wireless connection (for example CSR's Truewireless®) between the earphones 14, 16 enables earphone 16 to receive the appropriate audio channel. Alternatively, earphone 16 may be connected wirelessly to the source to receive the data directly from the source, rather than from the other earphone channel 14.

Commands are issued by the controller 10 in response to the controller 10 receiving user input. Such controls include: a fast forward command, a rewind command, a play command, a pause command and a stop command in order to control the source. The control commands are wirelessly received by the source 12, which then act on the commands, and control the playing of the media to the earphones 14, 16 as instructed.

Data may also be passed to the controller 10 via the source 12, and may be displayed, or some indication may be altered, to the user regarding the data.

For example, data relating to the status of the earphones 14, 16 may be presented to the user. The source 12 would receive such data from the earphones 14, 16 and then transmit this data to the controller 10 for display. Such data from the earphones 14, 16 may include: a connection status between the earphones, or between the earphones and source, and a battery level status of the earphones. Other data may also be possible.

Similarly, the source may also pass data to the controller that relates to the source, or the media stored by the source, or the earphones. For example, the source data may include: media data associated with the media and source device data indicating a condition, mode or status of the source. Some examples of source data include:
A pairing condition of the components in the wireless scheme (i.e. between the controller and source, or between the earphones and source, or between the earphones themselves)
Media Music Track Name
Media Artist Name
Media music status (playing, paused, next track, previous track)
Media volume
Emails and SMS text messages and/or notifications (when the source is a communications device such as a mobile phone)
Source battery conditions
Source signal condition (when the source is a communications device such as a mobile phone)
Caller name (when the source is a communications device such as a mobile phone)
Caller Number (when the source is a communications device such as a mobile phone)

The above is not an exhaustive list, and it may be apparent that other data may be possible.

Bluetooth® is one preferred wireless communication protocol used to connect the various devices in this connection scheme. Furthermore, various protocols or Bluetooth profiles may be used to pass data and control signals between the various devices in this connection scheme.

For example, in a first variant, the AVRCP (Audio/Video Remote Control Profile) may be used between the controller 10 and source 12 to provide control signals to the source. Data may be passed back to the controller 10 from the source 12 via a serial data profile. With regards to the connection between the earphone 14 and the source 12, a combination of A2DP (Advanced Audio Distribution Profile) and ACRCP may be used to pass media and control signals to the earphone 14, and may be used to pass control signals back to the source 12 from the earphone 14. As discussed above, the wireless connection between the earphones 14, 16 may for example be CSR's Truewireless® between the earphones 14, 16 to enable earphone 16 to receive the appropriate audio channel.

In a second variant, the connection schemes between each of the earphones 14, 16 may again be CSR's Truewireless®, and the Bluetooth® protocol between the source 12 and the earphone 14 may again be A2DP and ACRCP. However, in the second variant, the wireless connection between the controller 10 and the source 12 may instead be a Bluetooth Low Energy (BLE)® connection, in which case additional software may be required in order for the source 12 to parse the control commands. Using a BLE interface would advantageously save on battery power for the portable source and the portable controller.

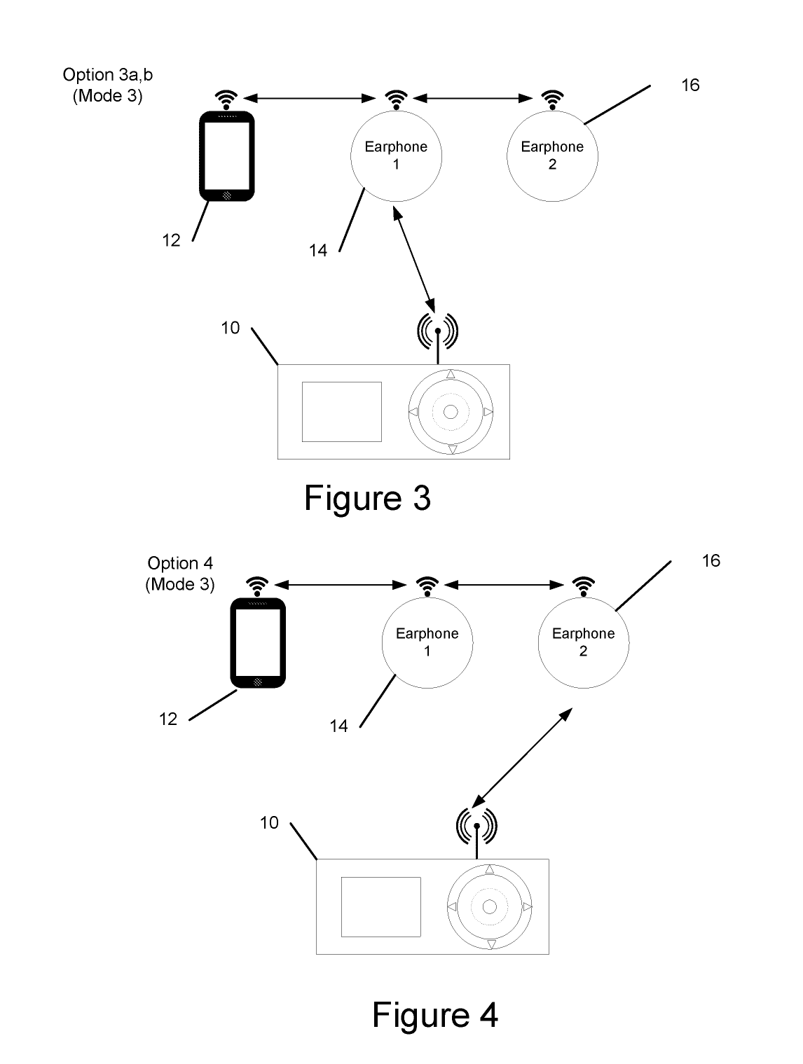

FIG. 3 illustrates a second connection scheme between a source 12, controller 10 and earphones 14, 16. In this scheme, the controller 10 wirelessly connects to the one of the earphones 14. One of the earphones 14 wirelessly connects to the source 12 to receive the media. A wireless connection (for example CSR's Truewireless®) between the earphones 14, 16 enables earphone 16 to receive the appropriate audio channel. Alternatively, earphone 16 may be connected wirelessly to the source to receive the data directly from the source, rather than from the other earphone channel 14.

As before, commands are issued by the controller 10 in response to the controller 10 receiving user input. Such controls include: a fast forward command, a rewind command, a play command, a pause command and a stop command in order to control the source. The control commands are wirelessly received by the earphone 14, which then passes on to the source 12, which are then acted on, and control the playing of the media to the earphones 14, 16 as instructed.

As with the scheme shown in FIG. 2, data may also be passed to the controller 10 from the source 12, this time via the earphone 14, and may be displayed, or some indication may be altered, to the user regarding the data. The examples discussed in relation to FIG. 2 are also appropriate examples here.

Similarly, the source may also pass data to the controller that relates to the source, or the media stored by the source, or the earphones. For example, the source data may include: media data associated with the media and source device data indicating a condition, mode or status of the source. The example source data discussed in relation to FIG. 2 are also appropriate example source data here.

Bluetooth® is one preferred wireless communication protocol used to connect the various devices in this connection scheme. Furthermore, various protocols or Bluetooth profiles may be used to pass data and control signals between the various devices in this connection scheme.

For example, in a first variant of this second scheme, the AVRCP (Audio/Video Remote Control Profile) and/or A2DP (Advanced Audio Distribution Profile) may be used between the source 12 and earphone 14, and the A2DP profile may be used between the controller 10 and earphone 14. In this scheme, control signals are passed to the earphone 14 and then forwarded to the source 12 for action. Similarly, data may be passed back to the controller 10 from the source 12 via the earphone 14 using A2DP or a serial data profile. And media is passed between source 12 and earphone 14. As discussed above, the wireless connection between the earphones 14, 16 may for example be CSR's Truewireless® between the earphones 14, 16 to enable earphone 16 to receive the appropriate audio channel.

In a second variant of this second scheme, the connection schemes between each of the earphones 14, 16 may again be CSR's Truewireless®, and the Bluetooth® protocol between the source 12 and the earphone 14 may again be A2DP and ACRCP. However, in the second variant, the wireless connection between the controller 10 and the earphone 14 may instead be a Bluetooth Low Energy (BLE)® connection, in which case additional software may be required in order for the earphone 14 to parse the control commands. Using a BLE interface would advantageously save on battery power for the portable source and the portable controller.

FIG. 4 illustrates a third connection scheme between a source 12, controller 10 and earphones 14, 16. In this scheme, the controller 10 wirelessly connects to the other earphone 16 compared to that in FIG. 3. The source 12 connects wirelessly to earphone 14, and the earphones 14, 16 wirelessly couple to each other. In this chain, the wireless connection between the earphones 14, 16, passes commands received by the controller 10 to the source 12 for action, and media passes to the earphone 14, 16 from the source 12. The wireless connection (for example CSR's Truewireless®) between the earphones 14, 16 enables earphone 16 to receive the appropriate audio channel. In this connection scheme, all data and commands between the controller and source are routed through each of the earphones 14, 16. One earphone may act as a master and the other as a slave, or both may have equal priorities.

As in the other, above mentioned, schemes, commands are issued by the controller 10 in response to the controller 10 receiving user input. Such controls include: a fast forward command, a rewind command, a play command, a pause command and a stop command in order to control the source. The control commands are wirelessly received by the source 12 (via the earphones 14, 16), which then act on the commands, and control the playing of the media to the earphones 14, 16 as instructed.

Data may also be passed to the controller 10 from the source 12 via the earphones 14, 16, and may be displayed, or some indication may be altered, to the user regarding the data. The examples given in the above schemes are also appropriate examples here.

Similarly, the source may also pass data to the controller that relates to the source, or the media stored by the source, or the earphones. The examples given in the above schemes are also appropriate examples here.

Bluetooth® is one preferred wireless communication protocol used to connect the various devices in this connection scheme. Furthermore, various protocols or Bluetooth profiles may be used to pass data and control signals between the various devices in this connection scheme.

In this scheme, the AVRCP (Audio/Video Remote Control Profile) and A2DP (Advanced Audio Distribution Profile) are used to connect the source 12 with one of the earphones 14. As discussed above, the wireless connection between the earphones 14, 16 may for example be CSR's Truewireless® between the earphones 14, 16 to enable earphone 16 to receive the appropriate audio channel. The AVRCP and/or serial profiles may be used to connect the controller to the other earphone 16. In this connection scheme, the connection between the earphones 14, 16 is used to pass control signals from the controller 10 to the source 12, and data from the source 12 and earphones 14, 16 to the controller 10.

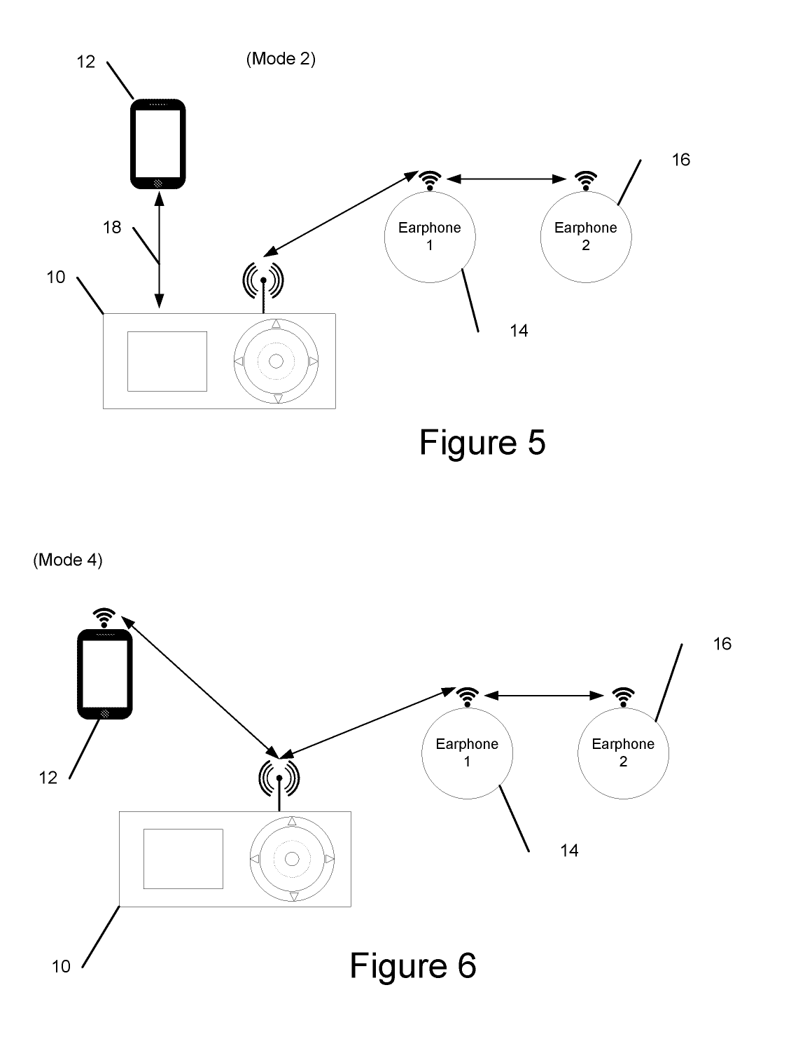

FIG. 5 illustrates a fourth connection scheme between a source 12, controller 10 and earphones 14, 16. In this scheme, the controller 10 connects to the source 12 via a wired connection 18, for example an Ethernet or serial connection. One of the earphones 14 wirelessly connects to the controller 10 to receive the media from the source 12 (via the controller 10). A wireless connection (for example CSR's Truewireless®) between the earphones 14, 16 enables earphone 16 to receive the appropriate audio channel.

As before, commands are issued by the controller 10 in response to the controller 10 receiving user input. Such controls include: a fast forward command, a rewind command, a play command, a pause command and a stop command in order to control the source. The control commands are received by the source 12 via the wired connection 18, which are then acted on, and control the playing of the media to the earphones 14, 16 as instructed.

As with the scheme shown in FIG. 2, data may also be passed to the controller 10 from the source 12, this time via the wired connection 18, and may be displayed, or some indication may be altered, to the user regarding the data. The examples discussed in relation to FIG. 2 are also appropriate examples here.

Similarly, the source may also pass data to the controller that relates to the source, or the media stored by the source, or the earphones. For example, the source data may include: media data associated with the media and source device data indicating a condition, mode or status of the source. The example source data discussed in relation to FIG. 2 are also appropriate example source data here.

Bluetooth® is one preferred wireless communication protocol used to connect the controller 10 and earphone 14 in this connection scheme. Furthermore, various protocols or Bluetooth profiles may be used to pass data and control signals between the various devices in this connection scheme.

For example A2DP (Advanced Audio Distribution Profile) may be used between the controller 10 and earphone 14. In this scheme, control signals are passed to the source 12 via the wired connection 18, media and data are passed from the source 12 via to the wired connection 18 to the controller. Media is passed to the earphone 14 from the controller 10 via A2DP, and data from the earphones 14, 16 is returned to the controller 10 via A2DP. As above, the wireless connection between the earphones 14, 16 may for example be CSR's Truewireless® between the earphones 14, 16 to enable earphone 16 to receive the appropriate audio channel.

In this configuration, the controller 10 is akin to a Bluetooth® dongle, which passes media received via a wired connection 18 to the wirelessly connected earphones 14, 16.

FIG. 6 illustrates a fifth connection scheme between a source 12, controller 10 and earphones 14, 16. In this scheme, which is similar to that of FIG. 5, the wired connection of FIG. 5 is replaced with a wireless connection. That is, the controller 10 connects to the source 12 wirelessly. One of the earphones 14 wirelessly connects to the controller 10 to receive the media from the source 12 (via the controller 10). A wireless connection (for example CSR's Truewireless®) between the earphones 14, 16 enables earphone 16 to receive the appropriate audio channel.

As before, commands are issued by the controller 10 in response to the controller 10 receiving user input. Such controls include: a fast forward command, a rewind command, a play command, a pause command and a stop command in order to control the source. The control commands are received by the source 12 via the wireless connection, which are then acted on, and control the playing of the media to the earphones 14, 16 as instructed.

As with the scheme shown in FIG. 2, data may also be passed to the controller 10 from the source 12, and may be displayed, or some indication may be altered, to the user regarding the data. The examples discussed in relation to FIG. 2 are also appropriate examples here.

Similarly, the source may also pass data to the controller that relates to the source, or the media stored by the source, or the earphones. For example, the source data may include: media data associated with the media and source device data indicating a condition, mode or status of the source. The example source data discussed in relation to FIG. 2 are also appropriate example source data here.

Bluetooth® is one preferred wireless communication protocol used to connect the controller 10 and earphone 14 in this connection scheme. Furthermore, various protocols or Bluetooth profiles may be used to pass data and control signals between the various devices in this connection scheme.

For example A2DP (Advanced Audio Distribution Profile) may be used between the controller 10 and earphone 14. In this scheme, control signals are passed to the source 12 via the wireless connection, which may for example be a AVRCP or serial connection, media and data are passed from the source 12 via to the wireless connection to the controller 10. Media is passed to the earphone 14 from the controller 10 via A2DP, and data from the earphones 14,16 is returned to the controller 10 via A2DP. As above, the wireless connection between the earphones 14, 16 may for example be CSR's Truewireless® between the earphones 14, 16 to enable earphone 16 to receive the appropriate audio channel.

In this configuration, the controller 10 is akin to a Bluetooth® dongle, which passes media received via a wireless connection to the wirelessly connected earphones 14, 16.

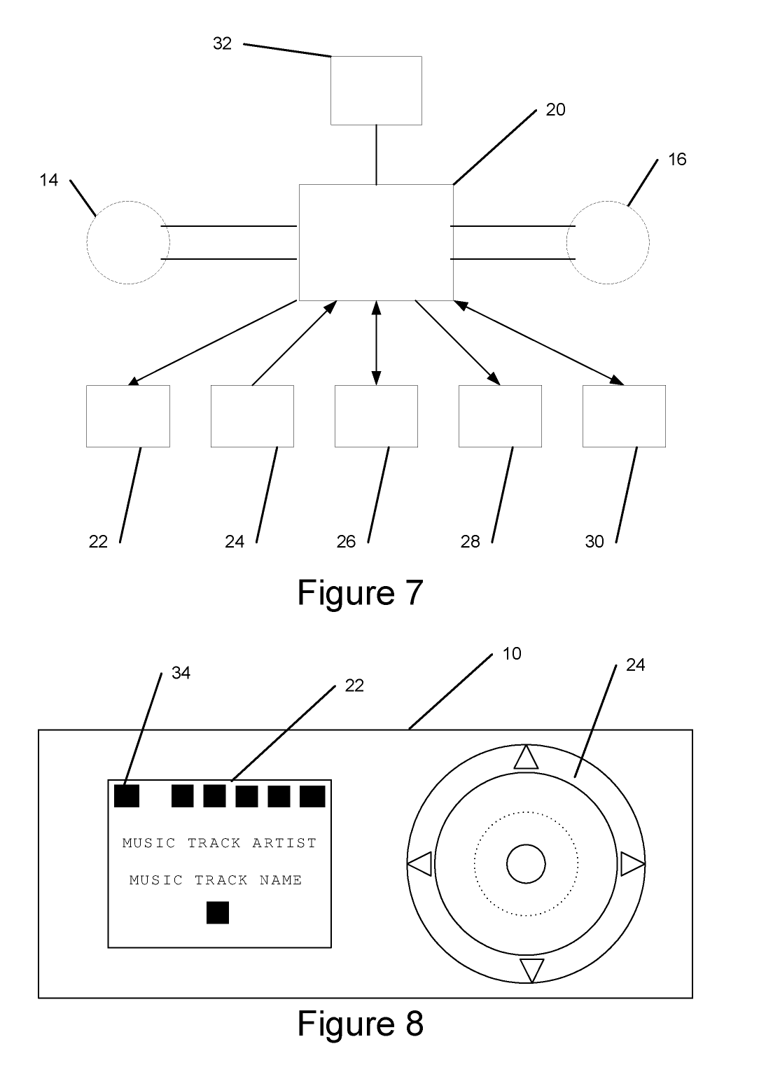

FIG. 7 shows a simplified block diagram of some of the components comprising the controller. As well as passing data and control signals back and fourth between a source 12 and earphones 14, 16, and displaying pertinent information relating to the media being played, a status of the source 12 or a status of the earphones 14, 16 or their respective connections, the controller has a number of other functions that it may perform.

The controller 10 comprises, for example, a battery source 32, which powers a central processing unit or controller 20. The battery source 32 may be used to power the controller 12 and also to recharge the portable wireless earphones 14, 16.

Coupled to the controller 20 are a number of other modules, for example a display 22, for displaying data as discussed above, a user input device 24 for receiving user input commands, one or more indicators 26 for indicating a status of the controller 10 or any of the devices coupled to the controller 10, a wireless interface 28 and a wired interface 30. Other modules may be used.

As mentioned above, the controller 10 may be used to charge the wireless earphones 14, 16.

As the earbuds/earphones are under size constraint, the battery used within them maybe restricted due to size, which limits the earbuds/earphones active use time. In order to overcome these limits the described portable charging system is used.

The earphones 14, 16 are connected to the controller 10 and receive power from the battery 32. They may be connected using a cable, or a connection interface may be provided in the controller 10 to receive the earphone 14, 16 in a connected state for charging.

The charging system has a secondary option of notifying earphone information during charging state. This works when the earphones are connected to the charging system. On the stage the charging power is detected to the earphone the original pairing state will transfer to connect to the charger instead at a low power communication. When charging power is disconnected the earphones' pairing state will automatically transfer back to the last device it was paired with.

Instead of a wired charging interface, the charging may be effected via an inductive, or wireless charging scheme, where the power is transferred from the battery to the earphones wirelessly when the earphones are in sufficient range with a powered wireless interface of the controller.

When the earphones are connected to the controller 10 in this way, the controller 10 may communicate with the earphones via 120. The 120 provides a data communication between the earphones and the charging system. Commands can be given to active pairing of the earphones and information can be retrieved about the earphones battery information during charging.

The controller 10 may limit the charging capabilities of the earphones and its own battery while it is connected to a low current power supply, this will allow the charging unit not to damage or impede the power supply regulations. The charging unit will provide priority for power to the internal circuity, in order for the charging unit to function correctly.

FIG. 8 shows an example interface of the controller 10 to enable the user to control the media being played and also to view data being received from the source 12 and earphones 14, 16.

An example user interface 24 is shown as a up/down/left/right/select control interface. It would be appreciated that this interface may be replaced with a touch screen interface or the like.

The display 22 shows a number of icons 34, which represent a variety of data that may be easily understood by the user relating to the operating conditions of the various devices in the wireless and wired connections. Furthermore, media data and other data may be displayed in more detail on the display 22.

For example, the following data may be presented:
pairing conditions
Music Track Name
Artist Name
Unread emails and SMS text messages
Mobile phone battery conditions
Chargers battery conditions
Earphones battery conditions
Mobile phones single condition
Music status (is it playing, paused, next track, previous track)
Volume (when using the jog dial on the navigation button)
Caller name
Caller Number
Bluetooth Connected
Earphone synced
USB connected status
Charging status
Status of third party technology (activated/deactivated)

This is not an exhaustive list.

The earphones 14, 16, may also comprise a number of advantageous features. Some examples are given below:

Adaptive sound dampening and Adaptive Noise Cancellation: This is used on the earphones themselves using the microphones built into the earphones, they will automatically correct external noise levels to normalise them to suitable levels for the user. If noise levels are low, the external sounds will be enhanced allowing the user to hear the environment while the streamed audio is mixed with external sound. When the external noise levels go beyond an unacceptable level the sound will be filtered removing unwanted static noise using either single or multiple band-pass filtering, to allow the user to still hear external noise with reduced static at a reasonable sound level. The user can also call for an option to cancel all external noise or set all external noise to be cancelled at a certain dB of noise level.

### Ear Disconnect Infrared Distance Sensor

This is used in the earphones themselves, it uses an infrared (IR) range sensor using an infrared beam and an infrared sensor to detect the reflected beam off the human skin. The range of activation is approximately 1 cm. When IR is sensed the earphone will re-pair and continue from its original state. If the IR is not sensed the earphone will go to sleep or low energy mode to conserve battery current.

If audio is streamed while the earphone is active, when the IR is not sensed then the streamed audio is paused automatically, if for a period the IR does not sense anything then will go to sleep or low energy mode.

### Capacitive Sensor

The earphones may have a capacitive sensor switch, to sense the capacitance of a body, like a finger or the head/ear. If the capacitive sensor come to close proximity of a human this will recognise it as a finger (for example a finger touching the top of the earphone) and will act as a switch/button. If the sensor senses a human body near it, it will sense it as an ear/head (example when the earphone is placed in the ear, even though its close it is not as close as a finger touching the top of the case), this will confirm the smart pause that it is in the ear.

This is to provide the smart pause a way of confirming if the earphones are in the ear or not using either IR sensor, capacitive sensor or both sensors to provide a broader option of sensing.

### Dual Bone Conduction Microphone with Vibration Filtering

Bone microphone are used to help provide users a way to communicate in noisy environment, but can come lead to not clear communication. This can be worse off when external vibration is involved causing the unwanted noise to be transferred. This external vibration can occur from the vibration of and engine when sitting on a motorbike or the use of a pneumatic drill. To elevate this, dual bone conduction microphone with filtering, can take two samples of bone vibrations from two different parts of the ear. One bone conduction microphone is set closest to the ear canal to take in to account the best vibration of the voice while the other is set to the cavity on the concha which will take into account the external vibration. During this process an active variable filtering will take into account the repetitive unwanted vibration and filter it out.

No doubt many other effective alternatives will occur to the skilled person. It will be understood that the invention is not limited to the described embodiments and encompasses modifications apparent to those skilled in the art lying within the scope of the claims appended hereto.

1. A wireless headphone system, comprising:
a controller coupleable to a source, and comprising a display and a user interface for receiving user commands; and
a pair of headphones comprising first and second headphone channels wirelessly coupled to each other, the pair of headphones being wirelessly coupleable to the controller or source, and configured to receive media from the source, to output the received media as audio, and to output headphone data,
wherein the controller is configured to receive source data from the source and the headphone data and to display the source data and headphone data to a user on the display, and wherein the controller is configured to issue user commands received from the user interface to the source to control the source.

2. The system according to claim 1, wherein, when the pair of headphones is wirelessly coupled to the source, the controller is wirelessly coupled to the source.

3. The system according to claim 2, wherein the controller is wirelessly coupled to the source via the pair of headphones.

4. The system according to claim 3, wherein the controller is wirelessly coupled to the first or second headphone channel.

5. The system according to claim 4, wherein the source is wirelessly coupled to the other of the second or first headphone channel.

6. The system according to claim 2, wherein the controller is configured to receive source data from the source via the pair of headphones, and configured to issue user commands to the source via the pair of headphones.

7. The system according to claim 1, wherein, when the pair of headphone is wirelessly coupled to the controller, the controller is coupled to the source.

8. The system according to claim 7, wherein the controller is coupled wirelessly to the source, or connected to the source using a wired connection.

9. The system according to claim 7, wherein the pair of headphones is configured to receive media from the source via the controller.

10. The system according to claim 1, wherein the controller is configured to issue control commands to the pair of headphones.

11. The system according to claim 1, wherein the controller comprises an input for receiving the pair of headphones in a wired connection.

12. The system according to claim 11, wherein the controller input comprises a docking port for receiving the pair of headphones in a wired connection.

13. The system according to claim 11, wherein the controller comprises a charging system, and wherein the controller is configured to charge the pair of headphones when the headphones are connected to the input in a wired connection.

14. The system according to claim 11, wherein when the pair of headphones are connected to the controller input in a wired connection, the controller is configured to issue a command to the pair of headphones to cause the pair of headphones also to be connected wirelessly to the controller.

15. The system according to claim 14, wherein, when the pair of headphones are disconnected from the controller input, the pair of headphones are configured to resume its wireless connection prior to being connected to the controller in a wired connection.

16. The system according to claim 1, wherein the user commands comprise one or more of a fast forward command, rewind command, play command, pause command and stop command in order to control the source.

17. The system according to claim 1, wherein the headphone data comprises one or more of a connection status, and a battery level status.

18. The system according to claim 1, wherein the source data comprises one of more of: media data associated with the media and source device data indicating a condition, mode or status of the source.

19. The system according to claim 1, wherein the controller user interface comprises one or more buttons or a touch-screen interface for issuing a user command.

20. The system according to claim 1, wherein the source comprises a mobile phone, a tablet computer, a laptop computer, a desktop computer, a games console or a media player.

21. The system according to claim 1, wherein the wireless protocol is Bluetooth.

22. The system according to claim 1, wherein the pair of headphones comprise in-ear headphones.

23. The system according to claim 1, wherein the first and second headphone channels comprise a respective first and second disconnect sensor for sensing when the respective first or second headphone channels are removed from a user.

24. The system according to claim 23, wherein the disconnect sensor comprises an optical sensor for detecting the presence of a user when in proximity of a user.

25. The system according to claim 23, wherein, when one or more of the first and second headphone channels are detected as being removed from a user, the detected removed channel headphone is configured to enter a low power consumption mode to reduce power consumption of the channel headphone, or the detected removed channel headphone is configured to turn off.

26. The system according to claim 23, wherein, when one or more of the first and second headphone channels are detected as being removed from a user, the controller is configured to pause or stop the media.

27. The system according to claim 1, wherein one or more channels of the headphones comprise a capacitive sensor to detect the presence of a body nearby the headphone channel, or adjacent the headphone channel, and wherein the detection of the presence of a body controls the operation of the headphone or the playing of the media.

28. The system according to claim 27, wherein the sensed body is part of the user using the headphones.

29. The system according to claim 28, wherein a body detected as being nearby the headphone channel by the capacitive sensor is a head or ear of the user, and a body detected as being adjacent the headphone channel is a finger of the user when the user presses a finger against the headphone channel.

30. The system according to claim 1, wherein the pair of headphones comprises an active noise control system for reducing background noise external to the pair of headphones being heard by the user.
